(19) United States
(12) Patent Application Publication
(10) Pub. No.: US 2020/0088500 A1
(43) Pub. Date: Mar. 19, 2020

(54) TARGET VERIFICATION AND SCORING SYSTEM

(71) Applicants: Andrew J. Lebbing, Aurora, IL (US); Yamin J. Reyes, Aurora, IL (US)

(72) Inventors: Andrew J. Lebbing, Aurora, IL (US); Yamin J. Reyes, Aurora, IL (US)

(21) Appl. No.: 16/575,452

(22) Filed: Sep. 19, 2019

Related U.S. Application Data
(60) Provisional application No. 62/733,600, filed on Sep. 19, 2018.

(51) Int. Cl. F41J 5/02; F41J 5/14; G06T 7/00; G06T 7/50

(52) U.S. Cl. CPC F41J 5/02; G06T 7/50; G06T 7/97; F41J 5/14

(57) ABSTRACT

A system for competitive target shooters to compete against themselves or other competitive users at the same or remote locations, wherein the system utilizes a high resolution digital camera on a smartphones, working in combination with computer software, to decipher and score users' target score submissions. The target score submissions are verified by various techniques and algorithms as well as various programming languages that allow users to be placed on leader boards

### CROSS-REFERENCE TO RELATED APPLICATION

This patent application claims priority to provisional patent application entitled “Method for Scoring Targets in Shooting Competitions” filed on Sep. 19, 2018, having Ser. No. 62/733,600, which is hereby incorporated by reference.

### BACKGROUND OF THE INVENTION

### Field of the Invention

The present invention relates generally target shooting and related competitions, and more particularly, to automated distance and target scoring verification systems.

### Description of Related Art

Shooting ranges for all types of projectiles remain popular. For example, use of conventional pistols and rifles at neighborhood gun ranges remains popular, and well as bow and arrow ranges. Newer technologies, such as airsoft guns, also have increased the demand for gun and similar projectile shooting ranges. In such environments, participants are typically burdened with the time consuming process of scoring and maintaining target records for individual shooters. Such a process can become very burdensome with a large group of participants, such as in tournament play, or just busy days on the weekends.

Such scoring and record keeping can impact the available time for a participant to use reserved time on a popular range. Similarly, the process of scoring and recording a large group of shooting participants can slow down the progress and enjoyment of time on the range.

Accordingly, there is a need for a system that can assist with the scoring and recording process of participants at a gun range to maximize the enjoyment and time available for participants to actively shoot on a gun range.

### ASPECTS AND SUMMARY OF THE PRESENT INVENTION

One aspect of the present invention is to provide a system to assist a participant with the scoring of targets on a projectile range, such as a gun range.

Another aspect of the present invention is to provide a system to assist in recording scores of targets.

A further aspect of the present invention is to provide a system for assisting in scoring targets and records of multiple players, such as during a tournament/match play.

An additional aspect of the present invention is to provide a system for automatically scoring and recording target scores of multiple players.

Another aspect of the present invention is to provide a system for interconnecting multiple players from different locations for simultaneous tournament/match play.

A further object of the present invention is to enable participants to locate gun ranges.

In order to provide these aspects and others, the present invention provides a system for competitive target shooters to compete against themselves or other competitive users at the same or remote locations. The targets can be of varying types for thrown or shot items, such as bullets from pistols or rifles, axes, darts, arrows, BBs, or air soft pellets. The system of the present invention utilizes a high resolution digital camera, such as those available on smartphones, working in combination with computer software to decipher and score users' target score submissions. The target score submissions are verified by various techniques and algorithms as well as various programming languages. The submitted scores also are can be viewed by participants.

The foregoing has outlined, rather broadly, the preferred features of the present invention so that those skilled in the art may better understand the detailed description of the invention that follows. Additional features of the invention will be described hereinafter that form the subject of the claims of the invention. Those skilled in the art should appreciate that they can readily use the disclosed invention and specific embodiments as a basis for designing or modifying other structures for carrying out the same purposes of the present invention, and that such other structures do not depart from the spirit and scope of the invention in its broadest form.

### BRIEF DESCRIPTION OF THE DRAWINGS

FIG. 1 is a diagram of an electronic camera located a distance “D” from a target in accordance with the present invention;

FIG. 2 is a step diagram of a process configured in accordance with the present invention;

FIGS. 3a-3c are flow diagram of the displays of a smartphone configured in accordance with the present invention;

FIG. 4 is a flowchart of a method configured in accordance with the present invention;

FIG. 5 is a diagram of a shooting range incorporating electronic cameras in accordance with the present invention; and

FIG. 6 is a target designed in accordance with the present invention.

### DETAILED DESCRIPTION OF THE PREFERRED EMBODIMENT

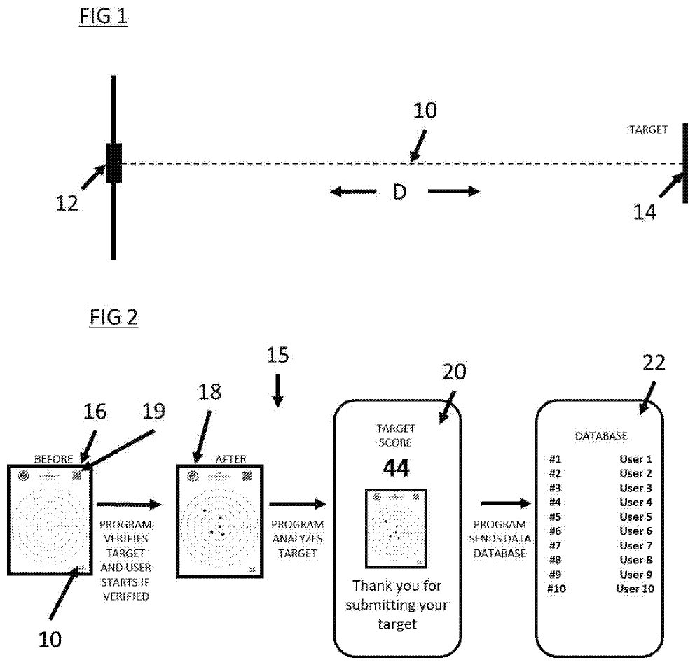

Referring now to the drawings, FIG. 1 is a diagram 10 of a smart phone 12 positioned a distance “D” from a projectile target 14. The smartphone can be an iPhone® or an Android®, or other smartphone having a high resolution camera, such as at least 8 megapixels, with cell, wifi, Bluetooth, or other wireless transmission capability. The distance “D” can be any distance, but preferably 10 to 50 feet. The target 14 preferably is constructed of paper of other material that can be penetrated by a projectile, such as a fired bullet, resulting in an aperture that can be visual detected by a smartphone camera.

FIG. 2 is a step diagram 15 illustrating the basic steps for scoring and submitting scored targets in accordance with the present invention. In diagram 16, the system verifies that a target 14 is clear of any holes or apertures, and further, the target has not be used or submitted for scoring based. The system checks the target number 17 or bar or QR code 19 on the target 14. Next the system verifies the distance D of the target 14 from the camera 12 by using an algorithm. For example, the distance D estimation can be performed by using an assumption that the target paper 14 is of a predetermined physical size, and using camera attributes such focal length, zoom (physical and digital), and additional properties of the lens of the camera.

In step diagram 18, the system analyses the target 14 for bullet or apertures holes, and score the target. The targets are photographed in black and white, and the target border is cropped to avoid extraneous data. The system uses computer vision (CV) algorithms to identify the target 14 and contour detection and shape recognition of the predominately white target. Furthermore, corrections to scanned or photographed images to align with a template image help the application program in order to correct defects in scanned image (such as corners, rings, text, etc.) are matched point to point as much as possible. Then a comparison is run between scanned images of target 14 in step images 16 and 18 to isolate and identify center points of sufficiently large enough “bullet holes” in the target of step 18. Additional comparison routines can include threshold of grey-scale differences, bounds comparison between the lighting, and size estimation.

In step diagram 20, a user can submit his or her target score, and confirmation of the submission is displayed on the smartphone. The system displays this information on a user's smartphone. Next in step diagram 22, the system submits a user's score to the system database, and scores of multiple players in a tournament of similar group event are displayed on the user's smartphone. Once verified by the system, a user can shoot at the target 14.

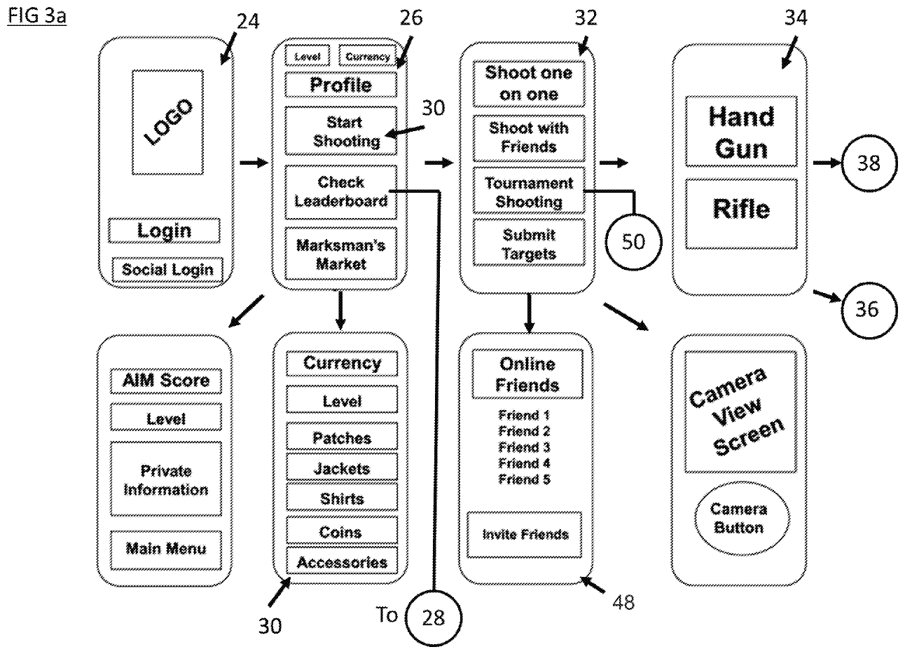

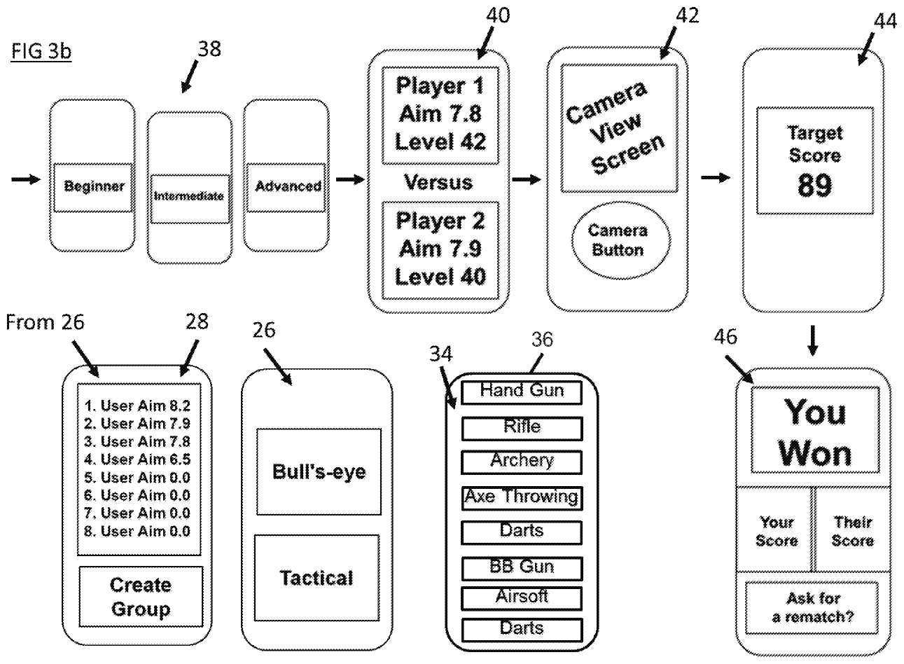

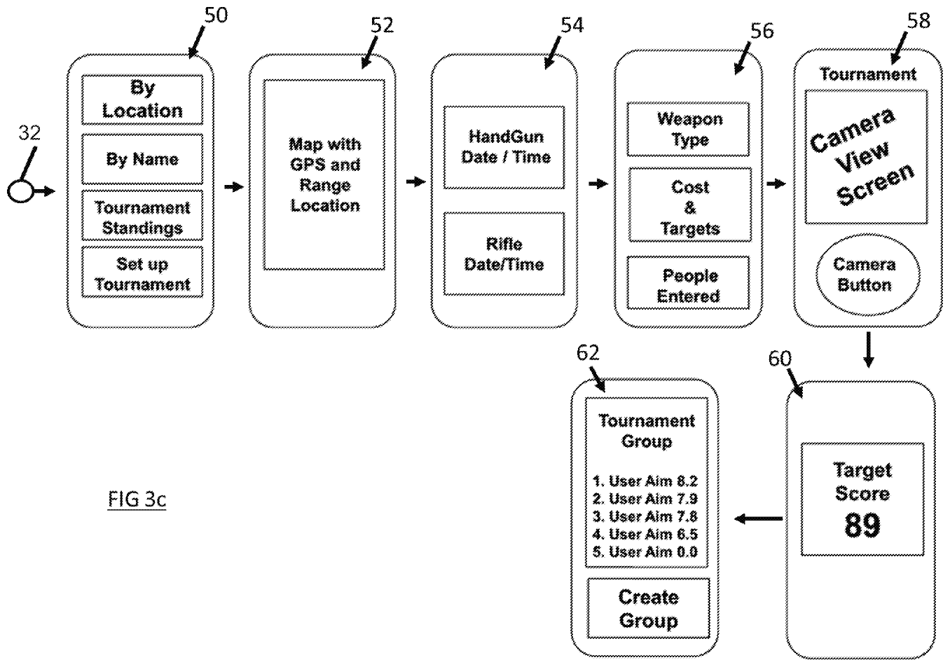

FIGS. 3a-3c are flow diagrams of the displays of a smartphone configured in accordance with the present invention. Referring first to the main menu shown in display step 24, a user can update their profile, begin shooting by selecting from various option to submit targets, and get ranked on the “Marksman's Club Platform” of the present invention. Further, a user can check the leader board to see where a user stands compared to other players in a user's selected shooting group.

A user also can select the “Marksman's Market” of the present invention where a user can buy or use electronic “coins” earned in shooting competitions to purchase clothing, patches, phone holders, and other items. A user can also buy more coins from the Markman's Market of the present invention.

Additionally, a user can select on the top left and right of the screen to see a user's current rank and available “currency.” Selecting either of these options directs the user to the Marksman's Market.

Screen display step 26 of the process of the present invention displays the User Profile which enables other players to see desired personal information about a player. The system will automatically register shooting scores in the profile, including an AIM (Average In-round Mark) score and a player's skill level. A user has the ability to determine what information is listed in different fields of his profile.

A user can select the Leaderboard display step 28 from the Profile display step 26. The Leaderboard display 28 allows a user to see where they stand amongst their piers on a real time leaderboard. Users can see they rank among all users or even create custom groups to be ranked based on such things as location, age, weapon type, etc. The rank preferably is based upon a user's AIM score. If a user has not entered a score, his AIM score will be 0.0.

As user can select the Markman's Market display step 30 from the Profile display 26. The Markman's Market is a place where the user goes to purchase items, such as shirts, jackets, patches, and currency.

A user can select the Start Shooting display step 30 from Profile display 26 which provides the options of Bull's-eye or Tactical. The tactical drills include charging drills, moving targets, and tactical decision courses. Infrared targets as well as moving targets also are included.

A user also can select the Start Shooting display step 32 from Profile display step 26. At the Shooting Display 32 a user has the options of shooting with one player, multiple friends, a tournament, of targets. Shoot with One allows two random players to compete. The system scores and verifies the users' video and then declares a winner once each video is submitted. The two users do not communication except for predetermined responses from the system.

Shoot with friends allows friends to compete over the internet from all over the world in shooting competitions. Levels of in-app currency will be determined by the users. Communication is available between users that are friends.

Tournament Shooting of display step 32 is hosted by local ranges to help grow usages and sales in those local ranges on specific days and times. The tournament is live between players and similar to shooting one to one competition.

The Submit Targets option of display step 32 allows a non-competitive player to submit his target and see where he falls on the Leaderboard.

The One on One Weapon selection display step 34 following Start Shooting display step 32 that enables a player to select the type of gun a user will be using in shooting one to one competition with another player on the system at the same time. Additionally, the system can provide an alternative display step 36 wherein the user has the option to select to shoot a hand gun, or a rifle, and also darts, arrows, axe, BB gun, or air soft gun.

Following Weapon Selection display step 34 is the Level Selection display step 38 offering Beginner, Intermediate, and Advanced levels. More levels can be provided in the Markman's Club of the present invention. The distance and amount of coins wagered goes up as the difficulty rises.

The Player Match Up display step 40 follows the Level Selection step display 38, wherein the system automatically takes your skill level, weapon choices, and selected difficulty level to match a user with an appropriate player. If no player is readily available to play user who is a suitable match, the user will play the system, which is programmed preferably to win 50% of the time.

The Submits Targets display step 42 follows the Player Match Up display step 40, wherein a user is ranked by the system. The system uses the camera phone and videotape of the shooting round to submit the shot target. Once the target is submitted electronically, the system will process the video and score the shot target. The target score is marked in a user's profile and then matched against the opponent to determine who won the shooting round.

The Target Score display step 44 follows the Submit Targets display step 42, wherein the system scores the target and reviews the video of the user for verification.

The Decision Review display step 46 follows the Target Score display step 44 wherein the system shows is a user has won or lost. A user can click on either their target or the opponent's target to zoom in on the targets if a user does not believe the outcome is correct. A user also can request a rematch with his prior opponent.

Referring back to Start Shooting display step 32, a user can select the option to Invite Friends, which moves to Invite Friends display step 48. A user can see how many of his friends are online, and can select to challenge an online friend. A user can also view a friend's Profile from this page. A user can set a future date to play with a friend, and the system will send a calendar date link to the phones of the user and his friend. Level of coins will also be determined by the user prior to sending the match invite.

Also from the Start Shooting display step 32, a use can select the Tournaments display step 50. The Tournament display step 50 enables a player to see what is happening at local ranges and locate a tournament in the area. A tournament can be located by name or location. A user can even set up custom tournaments for business or other organizations.

The Tournament by Location display step 52 enables a user to find a tournament by location using a user's phone GPS. Current and upcoming tournaments are displayed on a map which can be selected and scheduled by a user. The system then sends reminders to users for upcoming scheduled tournaments.

The Tournament Selection display step 54 follows the Tournament by Location display step 52, and enables a user to see the details of a tournament details at a specific range. This step 54 also notifies a user if a target for that user has been submitted for a particular tournament.

The Range Entry display step 56 follows the Tournament Selection display step 54 and provides information to a user about tournament details, such as targets, distance, entry cost, and how many people have entered.

Next, the Tournament Target Submission display step 58 is the same process as the Shoot One on One but with a tournament banner enabling a user to (a) tap the camera button to begin recording, (b) tap the camera button to stop recording, and (c) tap the submit button to submit target for verification. Once targets are submitted, the system will review, score, and submit the user's score to the tournament database and show the user when they stand on the live tournament leaderboard.

The Target Score display step 60 follows the Tournament Target Submission display step 58, wherein the system scores the targets and reviews the video of the user for verification.

The Tournament Leaderboard display step 62 follows the Target Score display step 60, wherein the system enable the user to see when they stand among their peers in this custom group on a real time leaderboard. A user's AIM score will be different from the overall AIM score, as in Tournament mode the AIM is based solely on a particular round of shooting.

From the Tournament Leaderboard display step 62, a user can still create custom groups that will be invite only, or open to groups based on location, age, weapon, and other criteria. The separate groups will not be part of the Tournament, and the overall AIM score will be used to place a user on the leaderboard.

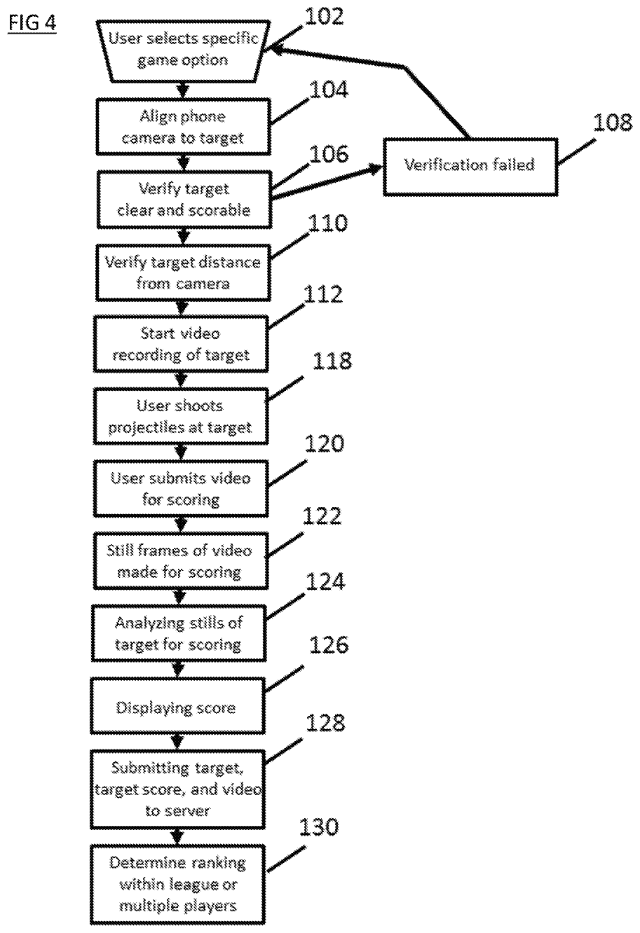

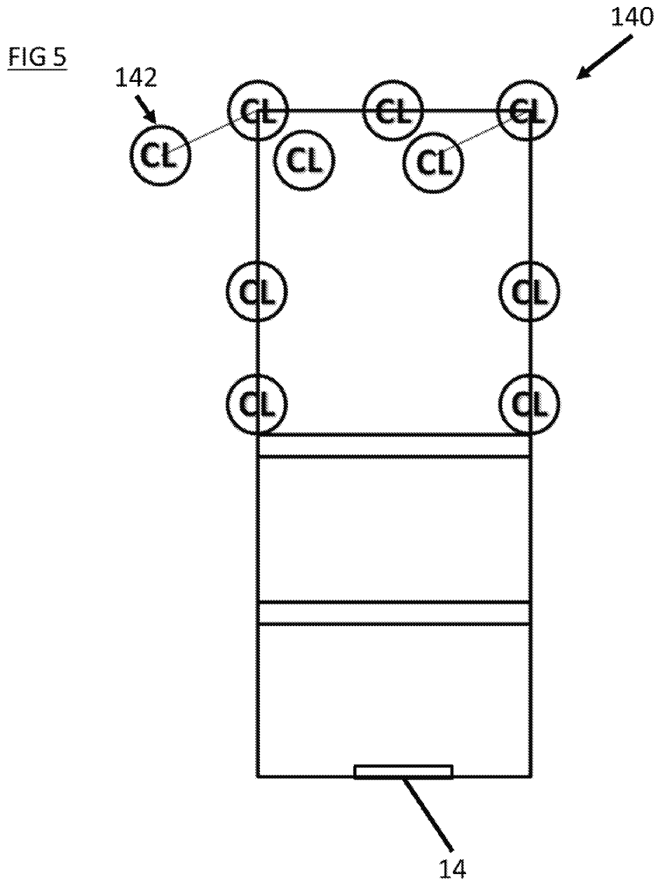

FIG. 4 is a flowchart 100 of the method of the present invention. Beginning at step 102, a user selects a specific game option using his personal cell phone. Next is step 104 wherein the user's phone is aligned with the shooting target. In step 106 the application program verifies the target is clear (unused) and scorable using the high resolution camera of the cell phone. If the verification step 106 fails, the process moves to step 108, signals a failure, and returns to the start of the application again at step 102.

If verification of the target in step 106 succeeds, then the method verifies the distance from the target in step 110. If the verification of the target distance fails in step 110, the method moves to step 108 indicating a failure, and returns to step 102.

Next in step 112 the method starts video recording of the target prior to shooting. In step 118 the user begins shooting, and in step 120 the shooter submits his video for scoring.

In step 122 the still frames from the video of the shooting are made for scoring purposes. In step 124 the method analyzes and scores the target. In step 126 the method displays a user's score. In step 128 a user submits the target, target score, and video to server to record. Finally in step 130, the method determines the ranking of the user's score and performance within a league of multiple players.

FIG. 5 illustrates a shooting diagram 140 having multiple cameras 142 for filming a shooter at a target 14 to provide feedback and educational training. The cameras 142 provide live video feed to offsite monitoring people who provide feedback to the user via an earpiece of the user. In an alternative embodiment, the cameras 142 are monitored by a computer system that takes a wire frame of the user to provide feedback on shooting form and target results using prerecording responses based upon shooter performance.

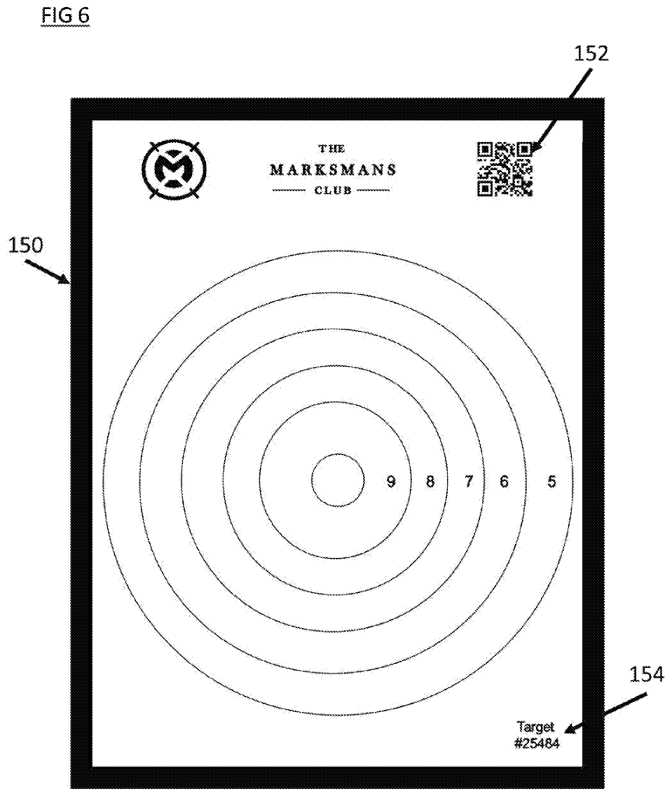

FIG. 6 is a diagram of a preferred design for a target 150 in accordance with the present invention. The target 150 includes a QR code 152 and target number 154 to identify the target 150 to the computer system.

While specific embodiments have been shown and described to point out fundamental and novel features of the invention as applied to the preferred embodiments, it will be understood that various omissions and substitutions and changes of the form and details of the invention illustrated and in the operation may be done by those skilled in the art, without departing from the spirit of the invention.

1. A method for scoring a shooter of projectiles at a range, comprising the steps of:
providing a smartphone having a camera and wireless communication;
providing a shooting target a distance D from the smartphone;
utilizing the smartphone camera to verify distance D of smartphone from the target;
utilizing the smartphone camera to verify the target is original and readable by the smartphone camera;
recording video and sound of shooting session of a player shooting the target;
generating still photographs of the target from the shooting session;
comparing the still photographs of the target from beginning of the shooting session and after the shooting session to determine score of the target based on detected apertures in the target; and
displaying score of the player on the smartphone.

2. The method of claim 1, further comprising the step of:
storing video and audio files for verification of the target.

3. The method of claim 1, further comprising the step of:
storing video and audio files for verification of weapon caliber.

4. The method of claim 1, further comprising the step of:
storing target score in a profile of the player.

5. The method of claim 4, further comprising the step of:
averaging target scores of the player.

6. The method of claim 4, further comprising the step of:
placing the target scores of the player on a leader board.

7. The method of claim 6, further comprising the steps of:
displaying scores of multiple players on the leader board; and
ranking the multiple players on the leader board based upon each of the multiple players average score (AIM Score).

8. The method of claim 4, wherein the player competes against their self by trying to achieve a better score than previously stored.

9. The method of claim 4, wherein the player competes against other players in a common tournament.

10. The method of claim 9, wherein the common tournament is hosted by a club.
